(19) United States
(12) Patent Application Publication
(10) Pub. No.: US 2015/0201184 A1
(43) Pub. Date: Jul. 16, 2015

(54) 3D DISPLAY DEVICE AND 3D DISPLAY METHOD

(71) Applicant: Shenzhen China Star Optoelectronics Technology Co. Ltd., Shenzhen, Guangdong (CN)

(72) Inventors: Xiangyang Xu, Shenzhen (CN); Wei-min Chang, Shenzhen (CN)

(21) Appl. No.: 14/238,257

(22) PCT Filed: Sep. 30, 2013
(86) PCT No.: PCT/CN2013/084671

§ 371 Date: Feb. 11, 2014

(30) Foreign Application Priority Data
Sep. 24, 2013 (CN) 201310440015.5

(51) Int. Cl. H04N 13/04; G09G 3/32

(52) U.S. Cl. CPC H04N 13/0404; G09G 3/32

(57) ABSTRACT

A 3D display device having a display unit and a glass is disclosed. The display unit includes a plurality of ultraviolet emission pixels and visible emission pixels. The glass at least includes a first lens and a second lens. The first lens is for converting the ultraviolet beams emitted from the ultraviolet emission pixels into visible light beams, and the second lens is for directly receiving the visible light beams emitted from the visible emission pixels. The 3D display device can highly separate the left parallax image and the right parallax image. In addition, the response time is short, the contrastness is high, the viewing angle is large, and the 3D display performance is good. A 3D display method using the above 3D display device is also disclosed.

### BACKGROUND OF THE INVENTION

1. FIELD OF THE INVENTION

The present disclosure relates to three dimensions (3D) display technology, and more particularly to the 3D display device incorporating an organic light emitting diode (OLED) display and the 3D display method.

2. Discussion of the Related Art

It is known that OLED display devices are characterized by self-illuminating attribute, and thus backlight sources are not needed. As such, the OLED display devices usually are thinner and lighter, and also, and the power consumption and the cost are low. In addition, the OLED display device also includes attributes such as high brightness, wide viewing angle, high contrastness, and flexibility, and thus attracts more and more peoples' attention.

OLED display devices include active matrix organic light emitting diode (AMOLED) and passive matrix organic light emitting diode (PMOLED). AMOLED display devices include attributes such as they can be large-scale integration, power saving, high resolution, and long life cycle, such that AMOLED has been paid a lot of attention while the consumers demand toward large-scale display panel has grown.

AMOLED display device includes a substrate, a thin film transistor (TFT) substrate, an OLED layer, and a cathode substrate layer. The TFTs operate as switches to control a current direction of each of the pixels. The OLED layer emits lights by carrier injection and recombination when being driven by an electric field. The principle is to adopt the indium tin oxide (ITO) transparent electrode and metallic electrode respectively to be the anode and the cathode. When being driven by a specific voltage, the electron and hole are respectively filled into the electron-and-hole transport layer via the anode and cathode. The electron and hole are respectively transferred to the light emitting layer via the electron-and-hole transport layer, and then encounter together to form the excitons such that the light emitting molecular is activated. The molecular emits lights after the radiation relaxation time. The radiation lights can be observed from one side of the ITO. In addition, the metallic electrode film also has the same function with the reflection layer.

3D display technology is the current trend of display field. Currently, 3D display technology is achieved by binocular disparity. That is, two parallax images, i.e., left and right parallax image, are shown on a two-dimensional display, and the left eye and right parallax image can only be respectively observed by users left and right eye by adopting certain technology.

Currently, 3D display technology mainly includes polarized 3D, shutter 3D, and color separation 3D display technologies. The polarized 3D display technology usually adopts space division methodology and thus half of the resolution is lost. As such, not only the 3D display performance is low, the viewing angle may be affected, which results in cross-talk. Shutter 3D display technology usually adopts time division methodology, which results in not only flashing images but also cross-talk. Color separation display technology adopts color complementary principle to filter most of colors, which results in great color distortion and reduced brightness. As such, the 3D display performance is also greatly reduced.

### SUMMARY

The object of the invention is to provide a 3D display device and a 3D display method such that the first image, i.e., the left parallax image, and the second image, i.e., the right parallax image are highly separated. In addition, the response time is short, the contrastness is high, and the viewing angle is large.

In one aspect, a 3D display device, comprising: a display unit and a glass, the display unit comprising a plurality of ultraviolet emission pixels and visible emission pixels, the glass at least includes a first lens and a second lens, and wherein the first lens is for converting the ultraviolet beams emitted from the ultraviolet emission pixels into visible light beams, and the second lens is for directly receiving the visible light beams emitted from the visible emission pixels.

In another aspect, a 3D display method using the above 3D display device comprising: controlling a plurality of ultraviolet emission pixels to emit ultraviolet beams to display a first image, and controlling a plurality of visible emission pixels to emit visible beams to display a second image; and converting the ultraviolet beams emitted from the ultraviolet emission pixels to the visible beams by a first lens, and directly receiving the visible beams emitted from the visible emission pixels by a second lens.

Preferably, the display unit is an OLED display.

Preferably, the first lens is a fluorescence lens.

Preferably, the visible emission pixels comprises a first visible emission subpixel, a second visible emission subpixel, and a third visible emission subpixel, and the first visible emission subpixel, a second visible emission subpixel, and a third visible emission subpixel are respectively one of three primary colors.

Preferably, the ultraviolet emission pixels includes a first ultraviolet emission subpixel, a second ultraviolet emission subpixel, and a third ultraviolet emission subpixel, and wherein wavelengths of the ultraviolet beams emitted from the first ultraviolet emission subpixel, the second ultraviolet emission subpixel, and the third ultraviolet emission subpixel are different.

Preferably, the first lens respectively converts the ultraviolet beams emitted from the first ultraviolet emission subpixel, the second ultraviolet emission subpixel, and the third ultraviolet emission subpixel into one of the three primary colors.

Preferably, when the ultraviolet beams emitted from the ultraviolet emission pixels pass through the first lens, a brightness of the converted visible beams converted by the first lens is the same with the brightness of the visible beams emitted from the visible emission pixels after the visible beams pass through the second lens.

Preferably, the ultraviolet emission pixels and the visible emission pixels are interleaved with each other along a column direction.

Preferably, the ultraviolet emission pixels and the visible emission pixels are interleaved with each other along a row direction.

In view of the above, the 3D display device includes a display unit and a glass cooperative operate with the display unit. The display unit includes a plurality of ultraviolet emission pixels and visible emission pixels. A 2D display image is integrated after the visible beams enter the observers retina in a glasses-free mode. After wearing the glasses, the ultraviolet beams emitted from the ultraviolet emission pixels pass through the fluorescence lens and are red-shifted into visible beams so as to enter the observers retina together with the visible beams passing through the second lens to integrate the 3D image. Thus, the 3D display device can highly separate the left parallax image and the right parallax image. In addition, the response time is short, the contrastness is high, the viewing angle is large, and the 3D display performance is good.

### BRIEF DESCRIPTION OF THE DRAWINGS

FIG. 1 is a schematic view showing the pixel distribution of the display unit of the 3D display device in accordance with one embodiment.

FIG. 2 is a schematic view showing the pixel distribution of the display unit of the 3D display device in accordance with another embodiment.

FIG. 3 is a schematic view showing the pixel distribution of the display unit of the 3D display device in accordance with another embodiment.

FIG. 4 is a schematic view showing the pixel distribution of the display unit of the 3D display device in accordance with another embodiment.

FIG. 5 is a schematic view showing the display principle of the 3D display device in accordance with one embodiment.

FIG. 6 is a flowchart showing the 3D display method of the 3D display device in accordance with one embodiment.

### DETAILED DESCRIPTION OF THE EMBODIMENTS

As stated above, in order to overcome the problems of the current technology, the 3D display device of the claimed invention includes a display unit and a glass. The display unit includes a plurality of ultraviolet emission pixels and visible emission pixels. The glass at least includes a first lens and a second lens. The first lens is for converting the ultraviolet beams emitted from the ultraviolet emission pixels into visible light beams The second lens is for directly receiving the visible light beams emitted from the visible emission pixels.

Furthermore, the display unit preferably is an OLED display. The first lens preferably adopts fluorescence lens.

Embodiments of the invention will now be described more fully hereinafter with reference to the accompanying drawings, in which embodiments of the invention are shown. In the embodiments, preferably, a large-scale active AMOLED display is adopted as the display unit as one example. It can be understood that other OLED, such as Passive Matrix Organic Light Emitting Diode (PMOLED), can also be adopted.

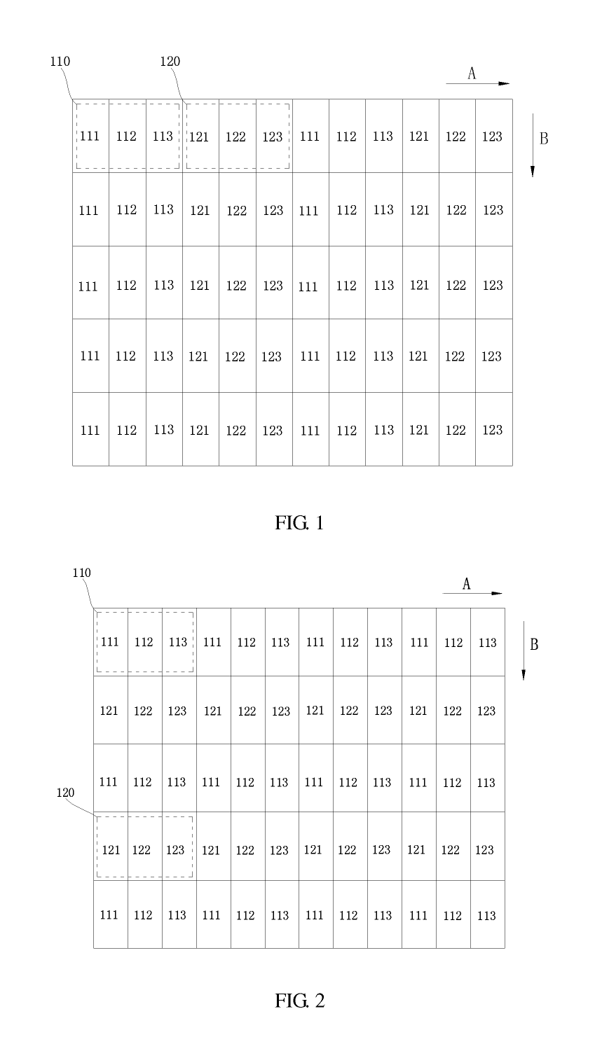

FIG. 1 is a schematic view showing the pixel distribution of the display unit of the 3D display device in accordance with one embodiment.

As shown in FIG. 1, the display unit of the 3D display device includes a plurality groups arranged along the direction “A”, i.e., the row direction. The group includes interleaved ultraviolet emission pixels 110 and visible emission pixels 120. However, the ultraviolet emission pixels 110 and the visible emission pixels 120 are arranged along the direction “B”, i.e., the column direction. That is, any of the columns along the direction “B” is filled with the ultraviolet emission pixels 110 or the visible emission pixels 120. The ultraviolet emission pixels 110 include a first ultraviolet emission subpixel 111, a second ultraviolet emission subpixel 112, and a third ultraviolet emission subpixel 113. The visible emission pixels 120 include a first visible emission subpixel 121, a second visible emission subpixel 122, and a third visible emission subpixel 123. The first ultraviolet emission subpixel 111, the second ultraviolet emission subpixel 112, and the third ultraviolet emission subpixel 113 are a plurality of adjacent OLED circuits for providing ultraviolet beams with different wavelengths. The emission wavelengths of the ultraviolet beams are controlled by the emission material of the OLED circuits. The emission material includes organic compounds such as carbazole, fluorine, triphenylamine, and quinquephenyl. The first visible emission subpixel 121, the second visible emission subpixel 122, and the third visible emission subpixel 123 are a plurality of adjacent OLED circuits for providing different visible beams, and the wavelengths of the visible beams are controlled by the emission material of the OLED circuits. In one embodiment, the visible beams are respectively red beams, green beams, and blue beams In other embodiments, the visible beams may include yellow beams. That is, the emission pixels are capable of providing a plurality of combination of visible beams, such as red beams, green beams, blue beams and yellow beams.

The first ultraviolet emission subpixel 111, the second ultraviolet emission subpixel 112, and the third ultraviolet emission subpixel 113 of each of the ultraviolet emission pixels 110 are arranged along the row direction, as indicated by “A”. The first visible emission subpixel 121, the second visible emission subpixel 122, and the third visible emission subpixel 123 of the visible emission pixels 120 are also arranged along the row direction “A”. At the same time, the ultraviolet emission pixels 110 and the visible emission pixels 120 are interleaved along the row direction “A.”

It can be understood that the configuration of the pixels of the display unit is not limited to FIG. 1. In other embodiments, as shown in FIG. 2, the first ultraviolet emission subpixel 111, the second ultraviolet emission subpixel 112, and the third ultraviolet emission subpixel 113 of the ultraviolet emission pixels 110 are arranged along the row direction “A”. The first visible emission subpixel 121, the second visible emission subpixel 122, and the third visible emission subpixel 123 of the visible emission pixels 120 are also arranged along the row direction “A”. The ultraviolet emission pixels 110 and the visible emission pixels 120 are arranged along the direction indicated by “B” in sequence. In other words, the ultraviolet emission pixels 110 and the visible emission pixels 120 are interleaved with each other with respect to the direction “B”. As such, any one of the rows is arranged with the ultraviolet emission pixels 110 or the visible emission pixels 120.

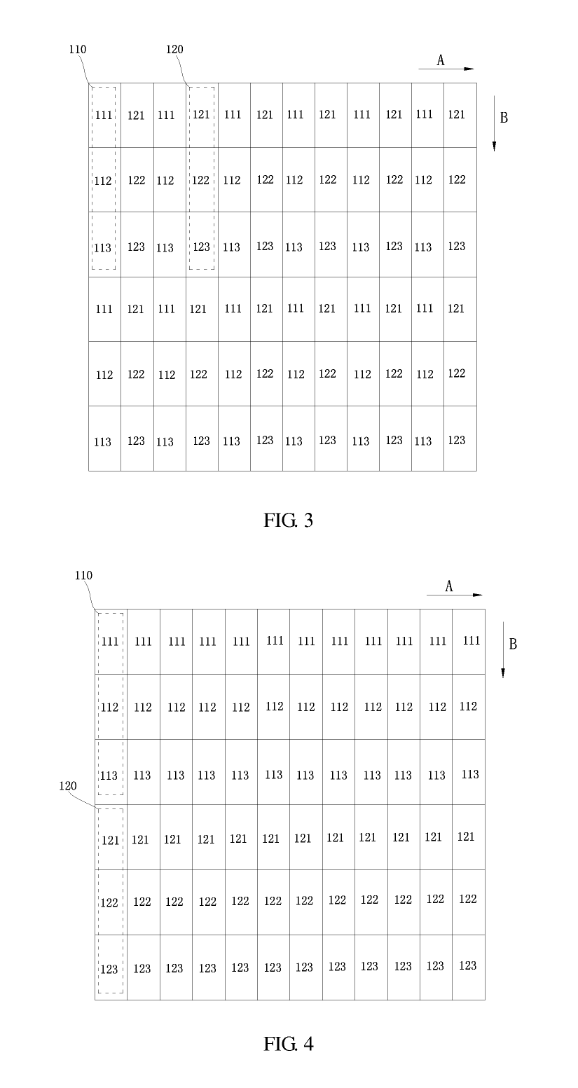

Alternatively, in another embodiment as shown in FIG. 3, the ultraviolet emission pixels 110 and the visible emission pixels 120 are interleaved with each other with respect to the direction “A”. And any one of the columns is arranged with the ultraviolet emission pixels 110 or the visible emission pixels 120. The first ultraviolet emission subpixel 111, the second ultraviolet emission subpixel 112, and the third ultraviolet emission subpixel 113 of the ultraviolet emission pixels 110 are arranged along the column direction “B” in sequence. The first visible emission subpixel 121, the second visible emission subpixel 122, and the third visible emission subpixel 123 of the visible emission pixels 120 are arranged along the column direction “B.”

Alternatively, in another embodiment as shown in FIG. 4, the ultraviolet emission pixels 110 and the visible emission pixels 120 are interleaved with each other along the direction “B”. Any one of the rows along the direction “A” is arranged with the ultraviolet emission pixels 110 or the visible emission pixels 120. The first ultraviolet emission subpixel 111, the second ultraviolet emission subpixel 112, and the third ultraviolet emission subpixel 113 of the ultraviolet emission pixels 110 are arranged along the column direction, i.e., the direction “B”. The first visible emission subpixel 121, the second visible emission subpixel 122, and the third visible emission subpixel 123 of the visible emission pixels 120 are arranged along the column direction “B.” It can be understood that the ultraviolet emission pixels 110 and the visible emission pixels 120 can be configured in other ways.

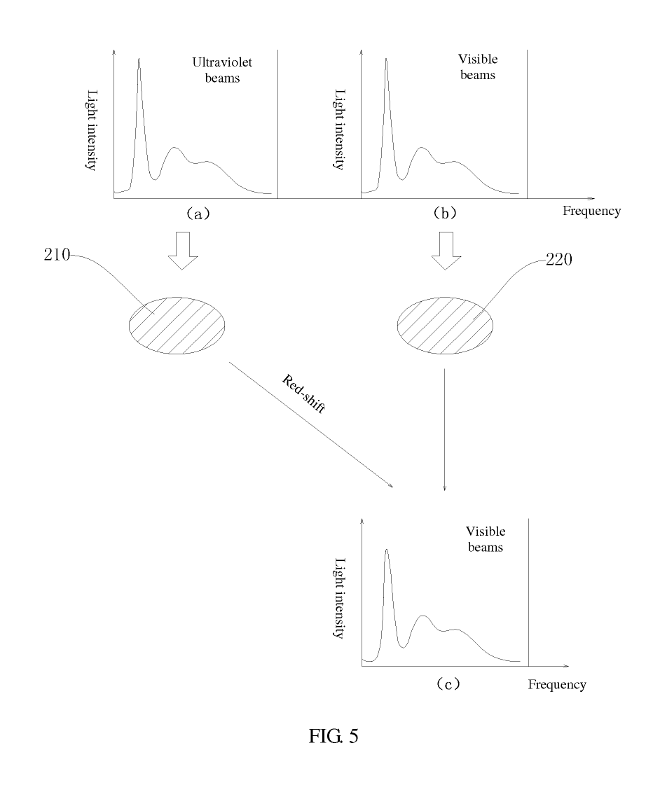

Referring to FIGS. 1 and 5, the 3D display device also includes a glass having a first lens 210 and a second lens 220. The first lens 210 is a fluorescence lens for converting the ultraviolet beams emitted from the ultraviolet emission pixels 110 to visible beams The second lens 220 is optical lens for directly receiving the visible beams emitted from the visible emission pixels 120. The second lens 220 proportionally degrades the spectrum intensity, i.e., light intensity, without changing the visible beams emitted from the visible emission pixels 120. In order to match the visible beams emitted from the visible emission pixels 120, the emission wavelengths of the first ultraviolet emission subpixel 111, the second ultraviolet emission subpixel 112, and the third ultraviolet emission subpixel 113 of the ultraviolet emission pixels 110 have to match with the first lens 210. When the ultraviolet beams emitted from the ultraviolet emission pixels pass through the first lens 210, the first lens 210 respectively converts the ultraviolet beams emitted from the first ultraviolet emission subpixel, the second ultraviolet emission subpixel, and the third ultraviolet emission subpixel into one of the three primary colors, i.e., red beams, green beams, and blue beams. Thus, the wavelengths of the ultraviolet beams emitted from the first ultraviolet emission subpixel, the second ultraviolet emission subpixel, and the third ultraviolet emission subpixel are different. For example, the first lens 210 is for converting the ultraviolet beams emitted from the first ultraviolet emission subpixel into red beams The first lens 210 is for converting the ultraviolet beams emitted from the second ultraviolet emission subpixel into green beams. The first lens 210 is for converting the ultraviolet beams emitted from the third ultraviolet emission subpixel into blue beams.

As the ultraviolet beams are converted into the visible beams by the first lens 210, the brightness of the converted visible beams is smaller than that of the ultraviolet beams. In order to eliminate the brightness difference between the first lens 210 and the second lens 220, the transmittance of the second lens 220 is determined by the spectrum intensity of the ultraviolet beams emitted from the ultraviolet emission pixels and the spectrum intensity of the converted visible beams after passing through the first lens 210. That is, the transmittance of the second lens 220 relates to a ratio of the spectrum intensity of the converted visible beams after passing through the first lens 210 to the spectrum intensity of the ultraviolet beams emitted from the ultraviolet emission pixels. Preferably, the ratio is 1:1.

The 3D display principle is shown in FIG. 5. The spectrogram of the ultraviolet beams emitted by the ultraviolet emission pixels 110 is shown in FIG. 5(a), and the spectral frequency is within the range of the ultraviolet beams When passing through the first lens 210, red shift phenomenon occurs for the ultraviolet beams emitted from the ultraviolet emission pixels 110. As such, the first lens 210 converts the ultraviolet beams emitted from the ultraviolet emission pixels 110 to the visible beams, and the spectral frequency of the visible beams is within the range of the visible beams, as shown in FIG. 5c. The spectrogram of the visible beams emitted from the visible emission pixels 120 is shown in FIG. 5(b), and the spectral frequency is within the range of the visible beams When the visible beams emitted from the visible emission pixels 120 passing through the second lens 220, the second lens 220 changes the brightness of the visible beams emitted from the visible emission pixels 120 to match the brightness of the converted visible beams after the ultraviolet beams emitted from the ultraviolet emission pixels 110 passes through the first lens 210. The emission spectrum is shown in FIG. 5c. The visible beams converted by the first lens 210 and the visible beams passing through the second lens 220 enter observers retina so as to integrate the 3D image.

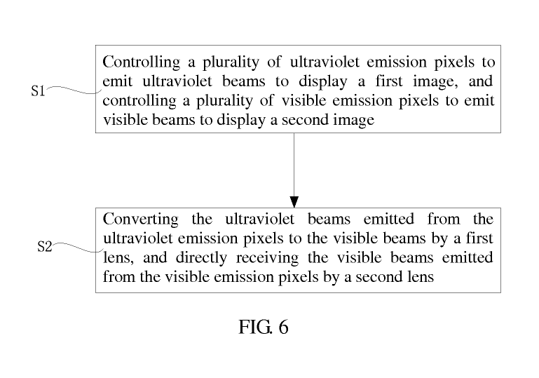

FIG. 6 is a flowchart showing the 3D display method of the 3D display device in accordance with one embodiment. The 3D display method of the 3D display device includes the following steps.

In step S1, a plurality of ultraviolet emission pixels are controlled to emit the ultraviolet beams to display the first image, i.e., the left parallax image, and a plurality of visible emission pixels are controlled to emit the visible beams to display the second image, i.e., the right parallax image.

In step S2, the ultraviolet beams emitted from the ultraviolet emission pixels are converted to the visible beams by the first lens, and the visible beams emitted from the visible emission pixels are directed received by the second lens.

In view of the above, the 3D display device includes a display unit and a glass cooperative operate with the display unit. The display unit includes a plurality of ultraviolet emission pixels and visible emission pixels. 2D display image is integrated after the visible beams enter the observers retina in a glasses-free mode. After wearing the glasses, the ultraviolet beams emitted from the ultraviolet emission pixels pass through the fluorescence lens and are red-shifted into visible beams so as to enter the observers retina together with the visible beams passing through the second lens to integrate the 3D image. Thus, the 3D display device can highly separate the left parallax image and the right parallax image. In addition, the response time is short, the contrastness is high, the viewing angle is large, and the 3D display performance is good.

It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A 3D display device, comprising:
a display unit and a glass, the display unit comprising a plurality of ultraviolet emission pixels and visible emission pixels, the glass at least includes a first lens and a second lens, and wherein the first lens is for converting the ultraviolet beams emitted from the ultraviolet emission pixels into visible light beams, and the second lens is for directly receiving the visible light beams emitted from the visible emission pixels.

2. The 3D display device as claimed in claim 1, wherein the display unit is an OLED display.

3. The 3D display device as claimed in claim 1, wherein the first lens is a fluorescence lens.

4. The 3D display device as claimed in claim 1, wherein the visible emission pixels comprises a first visible emission subpixel, a second visible emission subpixel, and a third visible emission subpixel, and the first visible emission subpixel, a second visible emission subpixel, and a third visible emission subpixel are respectively one of three primary colors.

5. The 3D display device as claimed in claim 1, wherein the ultraviolet emission pixels includes a first ultraviolet emission subpixel, a second ultraviolet emission subpixel, and a third ultraviolet emission subpixel, and wherein wavelengths of the ultraviolet beams emitted from the first ultraviolet emission subpixel, the second ultraviolet emission subpixel, and the third ultraviolet emission subpixel are different.

6. The 3D display device as claimed in claim 5, wherein the first lens respectively converts the ultraviolet beams emitted from the first ultraviolet emission subpixel, the second ultraviolet emission subpixel, and the third ultraviolet emission subpixel into one of the three primary colors.

7. The 3D display device as claimed in claim 1, wherein when the ultraviolet beams emitted from the ultraviolet emission pixels pass through the first lens, a brightness of the converted visible beams converted by the first lens is the same with the brightness of the visible beams emitted from the visible emission pixels after the visible beams pass through the second lens.

8. The 3D display device as claimed in claim 1, wherein the ultraviolet emission pixels and the visible emission pixels are interleaved with each other along a column direction.

9. The 3D display device as claimed in claim 1, wherein the ultraviolet emission pixels and the visible emission pixels are interleaved with each other along a row direction.

10. A 3D display method, comprising:
controlling a plurality of ultraviolet emission pixels to emit ultraviolet beams to display a first image, and controlling a plurality of visible emission pixels to emit visible beams to display a second image; and
converting the ultraviolet beams emitted from the ultraviolet emission pixels to the visible beams by a first lens, and directly receiving the visible beams emitted from the visible emission pixels by a second lens.

11. The 3D display method as claimed in claim 10, wherein the display unit is an OLED display.

12. The 3D display method as claimed in claim 10, wherein the first lens is a fluorescence lens.

13. The 3D display method as claimed in claim 10, wherein the visible emission pixels comprises a first visible emission subpixel, a second visible emission subpixel, and a third visible emission subpixel, and the first visible emission subpixel, a second visible emission subpixel, and a third visible emission subpixel are respectively one of three primary colors.

14. The 3D display method as claimed in claim 10, wherein the ultraviolet emission pixels includes a first ultraviolet emission subpixel, a second ultraviolet emission subpixel, and a third ultraviolet emission subpixel, and wherein wavelengths of the ultraviolet beams emitted from the first ultraviolet emission subpixel, the second ultraviolet emission subpixel, and the third ultraviolet emission subpixel are different.

15. The 3D display method as claimed in claim 14, wherein the first lens respectively converts the ultraviolet beams emitted from the first ultraviolet emission subpixel, the second ultraviolet emission subpixel, and the third ultraviolet emission subpixel into one of the three primary colors.

16. The 3D display method as claimed in claim 10, wherein when the ultraviolet beams emitted from the ultraviolet emission pixels pass through the first lens, a brightness of the converted visible beams converted by the first lens is the same with the brightness of the visible beams emitted from the visible emission pixels after the visible beams pass through the second lens.

17. The 3D display method as claimed in claim 10, wherein the ultraviolet emission pixels and the visible emission pixels are interleaved with each other along a column direction.

18. The 3D display method as claimed in claim 10, wherein the ultraviolet emission pixels and the visible emission pixels are interleaved with each other along a row direction.
